(19) United States
(12) Patent Application Publication
(10) Pub. No.: US 2025/0203705 A1
(43) Pub. Date: Jun. 19, 2025

(54) SELECTING FROM MULTIPLE DISCONTINUOUS RECEPTION CONFIGURATIONS

(71) Applicant: QUALCOMM Incorporated, San Diego, CA (US)

(72) Inventors: Sitaramanjaneyulu KANAMARLAPUDI, San Diego, CA (US); Diana MAAMARI, San Diego, CA (US); Prasad Reddy KADIRI, San Diego, CA (US); Linhai HE, San Diego, CA (US)

(21) Appl. No.: 18/540,528

(22) Filed: Dec. 14, 2023

(51) Int. Cl. H04W 76/28; H04W 28/02; H04W 52/02; H04W 72/232

(52) U.S. Cl. CPC H04W 76/28; H04W 28/0278; H04W 52/0274; H04W 72/232

(57) ABSTRACT

Various aspects of the present disclosure generally relate to wireless communication. In some aspects, a user equipment (UE) may receive configuration information indicating a plurality of discontinuous reception (DRX) configurations. The UE may communicate in accordance with a selected DRX configuration of the plurality of DRX configurations, wherein the selected DRX configuration is associated with one or more criteria comprising at least one of: a buffer status threshold, a delay status threshold, a power consumption threshold, or an active bandwidth part condition of the UE. Numerous other aspects are described.

### FIELD OF THE DISCLOSURE

Aspects of the present disclosure generally relate to wireless communication and specifically relate to techniques, apparatuses, and methods for selecting from multiple discontinuous reception configurations.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes receiving configuration information indicating a plurality of discontinuous reception (DRX) configurations; and communicating in accordance with a selected DRX configuration of the plurality of DRX configurations, wherein the selected DRX configuration is associated with one or more criteria comprising at least one of: a buffer status threshold, a delay status threshold, a power consumption threshold, or an active bandwidth part condition of the UE.

In some aspects, a method of wireless communication performed by a UE includes receiving configuration information indicating a plurality of search space set (SSS) or SSS group (SSSG) configurations; and communicating in accordance with a selected SSS or SSSG configuration of the plurality of SSS or SSSG configurations, wherein the selected SSS or SSSG configuration is associated with one or more criteria comprising at least one of: a buffer status threshold, a delay status threshold, a power consumption threshold, a DRX configuration condition, or an active bandwidth part condition of the UE.

In some aspects, an apparatus for wireless communication at a UE includes one or more memories; and one or more processors, coupled to the one or more memories, configured to cause the UE to: receive configuration information indicating a plurality of DRX configurations; and communicate in accordance with a selected DRX configuration of the plurality of DRX configurations, wherein the selected DRX configuration is associated with one or more criteria comprising at least one of: a buffer status threshold, a delay status threshold, a power consumption threshold, or an active bandwidth part condition of the UE.

In some aspects, an apparatus for wireless communication at a UE includes one or more memories; and one or more processors, coupled to the one or more memories, configured to cause the UE to: receive configuration information indicating a plurality of SSS or SSSG configurations; and communicate in accordance with a selected SSS or SSSG configuration of the plurality of SSS or SSSG configurations, wherein the selected SSS or SSSG configuration is associated with one or more criteria comprising at least one of: a buffer status threshold, a delay status threshold, a power consumption threshold, a DRX configuration condition, or an active bandwidth part condition of the UE.

In some aspects, a non-transitory computer-readable medium storing a set of instructions for wireless communication includes one or more instructions that, when executed by one or more processors of a UE, cause the UE to: receive configuration information indicating a plurality of DRX configurations; and communicate in accordance with a selected DRX configuration of the plurality of DRX configurations, wherein the selected DRX configuration is associated with one or more criteria comprising at least one of: a buffer status threshold, a delay status threshold, a power consumption threshold, or an active bandwidth part condition of the UE.

In some aspects, a non-transitory computer-readable medium storing a set of instructions for wireless communication includes one or more instructions that, when executed by one or more processors of a UE, cause the UE to: receive configuration information indicating a plurality of SSS or SSSG configurations; and communicate in accordance with a selected SSS or SSSG configuration of the plurality of SSS or SSSG configurations, wherein the selected SSS or SSSG configuration is associated with one or more criteria comprising at least one of: a buffer status threshold, a delay status threshold, a power consumption threshold, a DRX configuration condition, or an active bandwidth part condition of the UE.

In some aspects, an apparatus for wireless communication includes means for receiving configuration information indicating a plurality of DRX configurations; and means for communicating in accordance with a selected DRX configuration of the plurality of DRX configurations, wherein the selected DRX configuration is associated with one or more criteria comprising at least one of: a buffer status threshold, a delay status threshold, a power consumption threshold, or an active bandwidth part condition of the apparatus.

In some aspects, an apparatus for wireless communication includes means for receiving configuration information indicating a plurality of SSS or SSSG configurations; and means for communicating in accordance with a selected SSS or SSSG configuration of the plurality of SSS or SSSG configurations, wherein the selected SSS or SSSG configuration is associated with one or more criteria comprising at least one of: a buffer status threshold, a delay status threshold, a power consumption threshold, a DRX configuration condition, or an active bandwidth part condition of the apparatus.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless network.

FIG. 3 is a diagram illustrating an example disaggregated base station architecture in accordance with the present disclosure.

FIG. 4 is a diagram illustrating an example associated with discarding multi-modal data packets, in accordance with the present disclosure.

FIG. 5 is a diagram illustrating an example of a discontinuous reception (DRX) configuration, in accordance with the present disclosure.

FIG. 6 is a diagram illustrating an example of selecting from multiple DRX configurations, such as for multi-modal data communication, in accordance with the present disclosure.

FIG. 7 is a diagram illustrating an example resource structure for wireless communication, in accordance with the present disclosure.

FIG. 8 is a diagram illustrating an example of physical downlink control channel (PDCCH) monitoring variation based on a bandwidth part (BWP) or DRX configuration, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a UE or an apparatus of a UE, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Communications in a wireless network may be conveyed via data packets, such as protocol data units (PDUs). The size of a data communication may sometimes exceed the size of a PDU, so the data communication may be split over multiple PDUs for transmission. It may be beneficial in some applications to group a set of data packets so that a receiver can process the set of data packets in accordance with the set of data packets being grouped. One mechanism for grouping data packets of a data communication is to designate the group of data packets as a PDU set. For example, the first device may transmit data associated with a video frame via a PDU set. A PDU set may correspond to an application data unit (ADU). An ADU is a unit of data. For example, an ADU may include a video frame, such as from an extended reality (XR) application, being sent between a network node and a user's head-mounted device (HMD). Different frames may have different coding mechanisms, based on the underlying protocol as well as the frame refresh rate.

Some applications, such as XR, may involve multi-modal data. Multi-modal data may include input data from different types of devices or sensors and/or output data to different types of destinations (such as one or more UEs), where the input data and/or the output data are associated with the same task or application. For example, multi-modal data may include more than one type of single-modal data, and there may be a dependency among each type of single-modal data included in the multi-modal data. Single-modal data can be seen as a single type of data. Examples of single-modal data include biometric voice data, words extracted from voice data, emotion information extracted from voice data, biometric face data, emotion information extracted from face data, gestures, relative location information, ambient information, and haptic information. An example of multi-modal data may include any combination of these single-modal data examples.

Some applications, such as XR, may benefit from synchronization of user experience of stimuli derived from different forms of data. For example, haptic data may be used to create haptic feedback for a user. As another example, audio data may be synchronized with video data, and these data may be synchronized with the haptic data to improve user experience. A synchronization threshold can be defined as the maximum tolerable temporal separation of the onset of two stimuli, one of which is presented to one sense (of a user) and the other to another sense (of the user), such that the accompanying sensory objects are perceived as being synchronous. For example, multi-modal data may benefit from providing different stimuli in accordance with corresponding synchronization thresholds.

Devices providing multi-modal data may transmit single-modal data (e.g., haptic data, sensing data) with different periodicities. As an example, a device may send one packet containing haptic information to an application server every 2 milliseconds (ms), and may send packets related to sensing information to the application server every 4 ms. Thus, the haptic data and sensing data may be transferred in a 5G network via two separate flows. The quantity of haptic packets that are generated and transferred within one second may include 1000 to 4000 packets (without haptic compression encoding), or 100 to 500 packets (with haptic compression encoding). The size of each haptic packet may be related to the degree-of-freedom (DoF) capacity that a haptic device supports (e.g., the data size for one DoF may be 2 to 8 bytes).

According to uplink data from the devices (corresponding to different single-mode data), the application server performs operations including rendering and coding video, processing audio, and processing haptic model data. The application server may then periodically send the downlink data to devices (at the corresponding periodicities) with different respective time periods, such as via a 5G or 6G network. Some types of single-modal data are predictable in the time domain (such as data with a frame periodicity like video) and other types of single-modal data are unpredictable (such as sensing data). And different types of data may have different latency requirements and synchronization between the inputs.

Reduction of power consumption is beneficial for a variety of reasons, including increasing the battery life of a UE and reducing network energy consumption. One way to achieve power savings is to reduce the amount of time or energy spent monitoring for a physical downlink control channel (PDCCH). In some examples, the UE may implement a discontinuous reception (DRX) cycle to achieve this. In a DRX cycle, a UE is configured with an on duration, an inactivity timer, and a cycle length. The UE may monitor for data (e.g., by monitoring for a PDCCH) during an on duration. If data is received during the on duration, the UE may remain active (by continuing to monitor for or receive data) during for the length of the inactivity timer. Once the inactivity timer has expired, the UE may enter a lower power state (e.g., cease monitoring for or receiving data) until the next on duration. In some aspects, a UE can be configured with multiple DRX configurations that are different from one another with regard to at least one of the on duration, the inactivity timer, or the cycle length.

Switching between multiple different DRX cycles may be beneficial in the context of multi-modal data communication. For example, a first DRX cycle may provide suitable performance for video traffic and a second DRX cycle may provide suitable performance for haptic data. However, if the UE and the network do not have information indicating a currently active DRX cycle at the UE, the benefits of the DRX cycle for reduction of power consumption may be reduced or eliminated. Some approaches for switching between multiple DRX cycles, such as switching based on a mapping from logical channels or flows to DRX configurations, may lack flexibility to enable multi-modal data communication across different patterns of traffic and error or latency thresholds (which may be used to ensure that synchronization thresholds are met). Furthermore, explicitly signaling configuration information to configure the currently active DRX cycle may be associated with overhead and latency.

Various aspects relate generally to switching between multiple configured DRX cycles. Some aspects more specifically relate to switching between DRX cycles according to dynamic conditions or traffic at a UE. In some aspects, a UE may be configured with a plurality of DRX configurations. The UE may communicate in accordance with a selected DRX configuration of the plurality of the DRX configurations. For example, the selected DRX configuration may be associated with a buffer status threshold, a delay status threshold, a power consumption threshold, or an active bandwidth part (BWP) of the UE. As one example, the UE may transmit a buffer status report (BSR), and may select the selected DRX configuration in accordance with the buffer status threshold and the BSR. As another example, the UE may transmit a delay status report (DSR), and may select the selected DRX configuration in accordance with the delay status threshold and the DSR. As yet another example, the UE may select the selected DRX configuration in accordance with the power consumption threshold, and may transmit an indication of the selected DRX configuration. As still another example, the UE may receive signaling that indicates the active BWP, and may select the selected DRX configuration based on an association between the DRX configuration and the active BWP.

Particular aspects of the subject matter described in this disclosure can be implemented to realize one or more of the following potential advantages. In some examples, by selecting the DRX configuration based on one or more of the above criteria, the described techniques can be used to select between different DRX cycles, which may be suitable for different types of single-modal data or different synchronization thresholds. Thus, conformance with synchronization thresholds may be achieved while decreasing power consumption and network energy consumption. Selecting the selected DRX configuration in accordance with the buffer status threshold may provide selection of the DRX configuration based on an amount of buffered data, which may provide for a shorter on duration or inactivity timer for low-data modes (e.g., haptic data) and a longer on duration or inactivity timer for high-data modes (e.g., video data). Furthermore, the BSR may provide the network with an indication of the amount of buffered data, enabling symmetric operation. Selecting the selected DRX configuration in accordance with the delay status threshold may provide selection of the DRX configuration based on an amount of observed delay, which enables switching to a more aggressive DRX cycle or deactivating DRX when delay is unacceptable for a given mode of data. Furthermore, the DSR may provide the network with an indication of the delay, enabling symmetric operation. Selecting the selected DRX configuration in accordance with the power consumption threshold may enable power saving when power consumption of the UE (or transmit power of the UE, or the like) exceeds a threshold. In this example, transmitting an indication of the selected DRX configuration may enable the network to operate symmetrically with the UE. Selecting the selected DRX configuration in accordance with the active BWP enables the UE to use a suitable DRX configuration for a given BWP, which may also be a suitable DRX configuration given traffic conditions at the UE (since the active BWP may be selected based on traffic patterns (e.g., BSR, latency) or radio characteristics (e.g., block error rate, cell loading). Thus, selecting from multiple DRX configurations based on the active BWP or the traffic characteristics gives better key performance indicators in terms of the throughput, block error rate (BLER), and latency, by ensuring that synchronous flows are addressed to meet the multi-modal traffic requirements for immersive XR.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

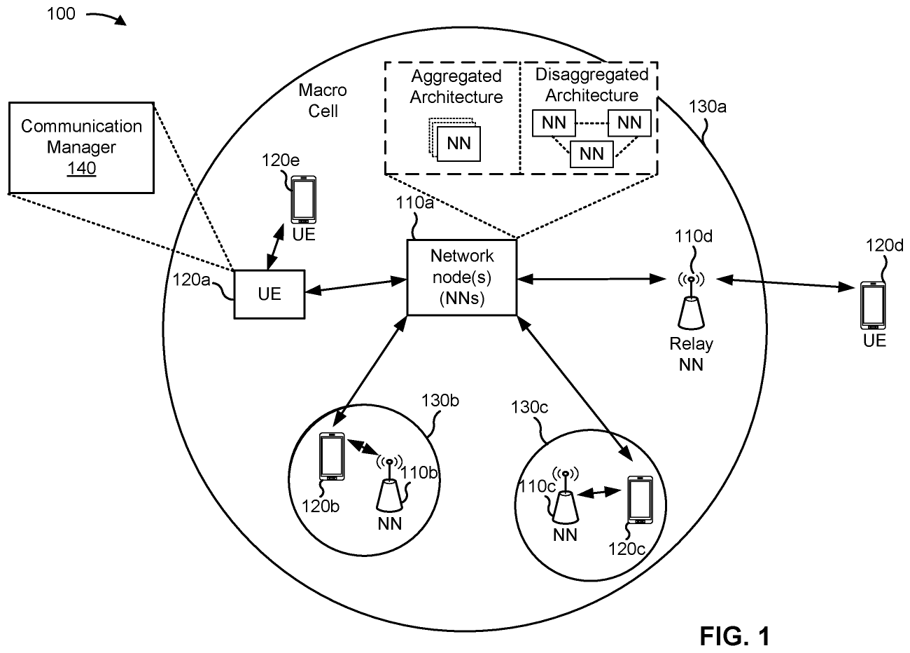

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels.

For example, devices of the wireless communication network 100 may communicate using one or more operating bands. In some aspects, multiple wireless communication networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive configuration information indicating a plurality of discontinuous reception (DRX) configurations; and communicate in accordance with a selected DRX configuration of the plurality of DRX configurations, wherein the selected DRX configuration is associated with one or more criteria comprising at least one of: a buffer status threshold, a delay status threshold, a power consumption threshold, or an active bandwidth part condition of the UE. In some aspects, the communication manager 140 may receive configuration information indicating a plurality of search space set (SSS) or SSS group (SSSG) configurations; and communicate in accordance with a selected SSS or SSSG configuration of the plurality of SSS or SSSG configurations, wherein the selected SSS or SSSG configuration is associated with one or more criteria comprising at least one of: a buffer status threshold, a delay status threshold, a power consumption threshold, a DRX configuration condition, or an active bandwidth part condition of the UE. Additionally, or alternatively, the communication manager 140 may perform one or more other operations described herein.

As indicated above, FIG. 1 is provided as an example. Other examples may differ from what is described with regard to FIG. 1.

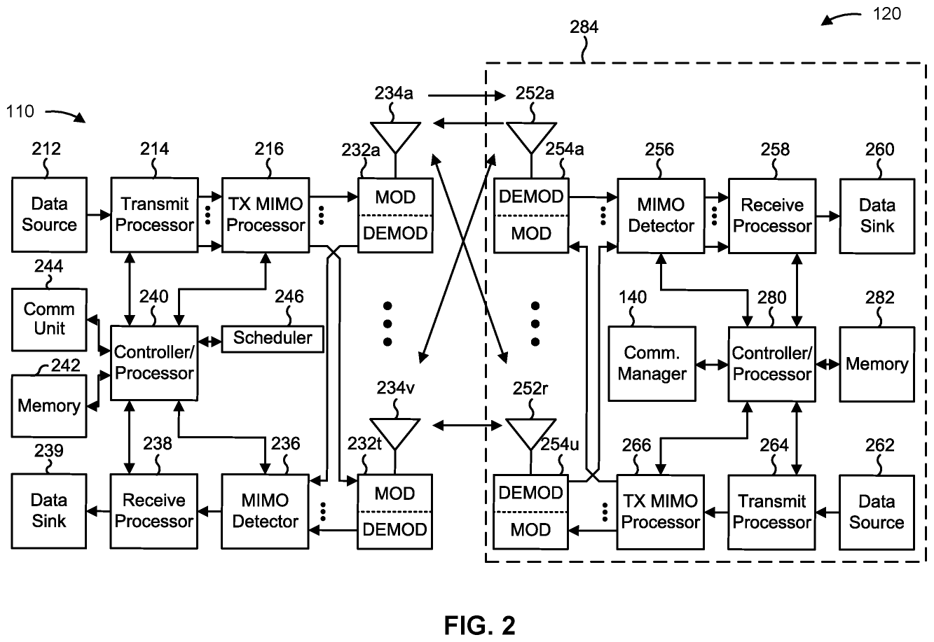

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254.

Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

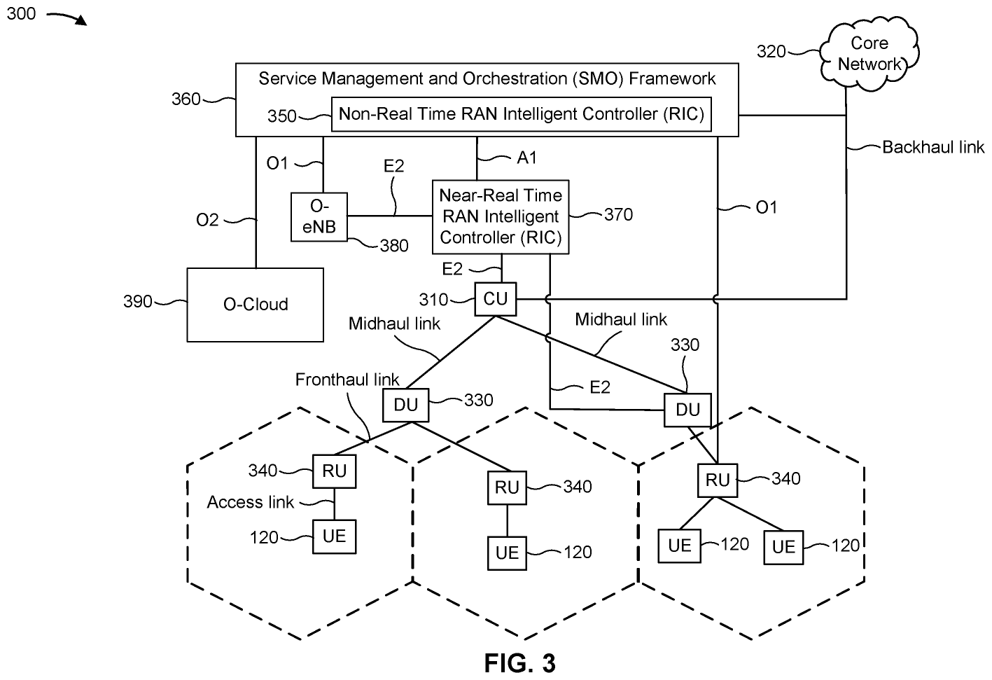

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

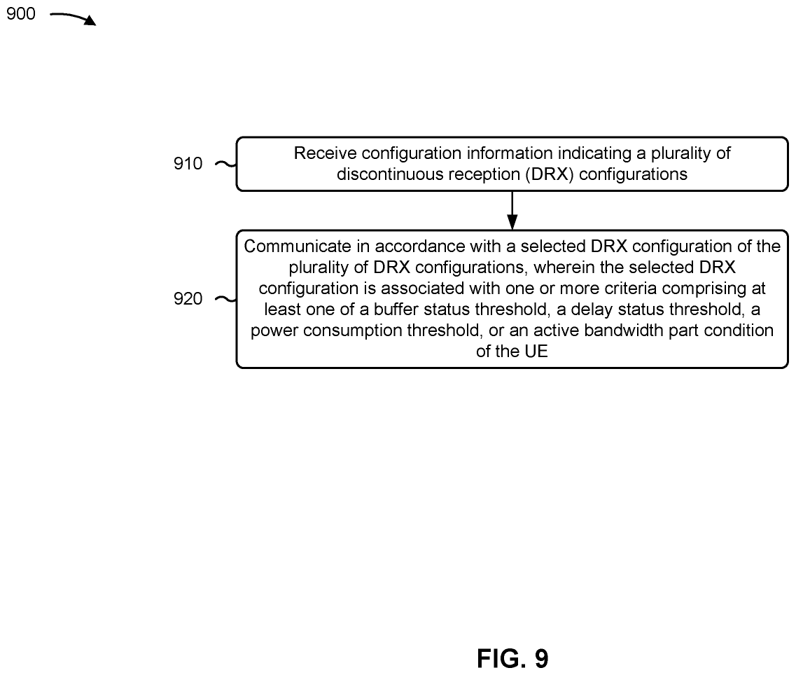

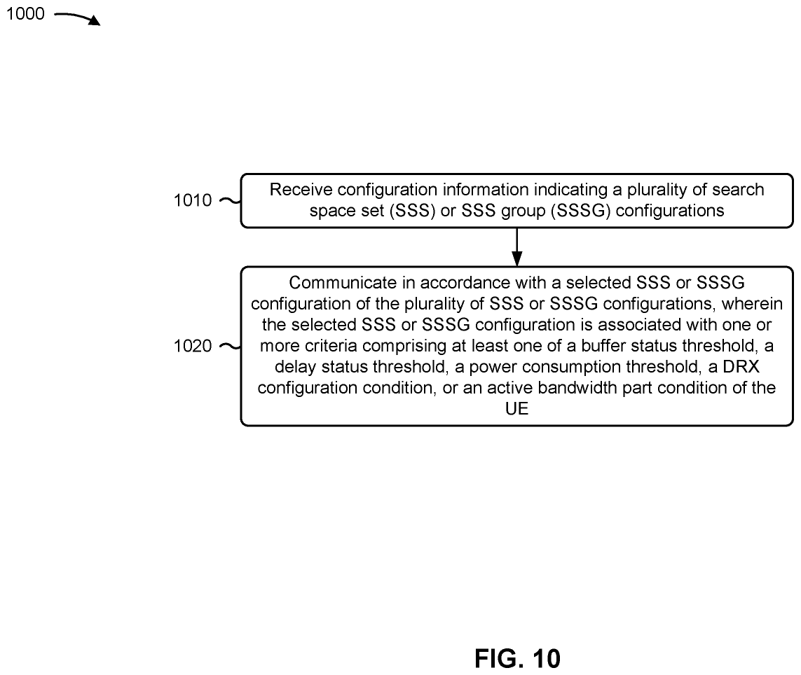

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with DRX or SSS/SSSG switching, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE includes means for receiving configuration information indicating a plurality of DRX configurations; and/or means for communicating in accordance with a selected DRX configuration of the plurality of DRX configurations, wherein the selected DRX configuration is associated with one or more criteria comprising at least one of: a buffer status threshold, a delay status threshold, a power consumption threshold, or an active bandwidth part condition of the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving configuration information indicating a plurality of SSS or SSSG configurations; and/or means for communicating in accordance with a selected SSS or SSSG configuration of the plurality of SSS or SSSG configurations, wherein the selected SSS or SSSG configuration is associated with one or more criteria comprising at least one of: a buffer status threshold, a delay status threshold, a power consumption threshold, a DRX configuration condition, or an active bandwidth part condition of the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

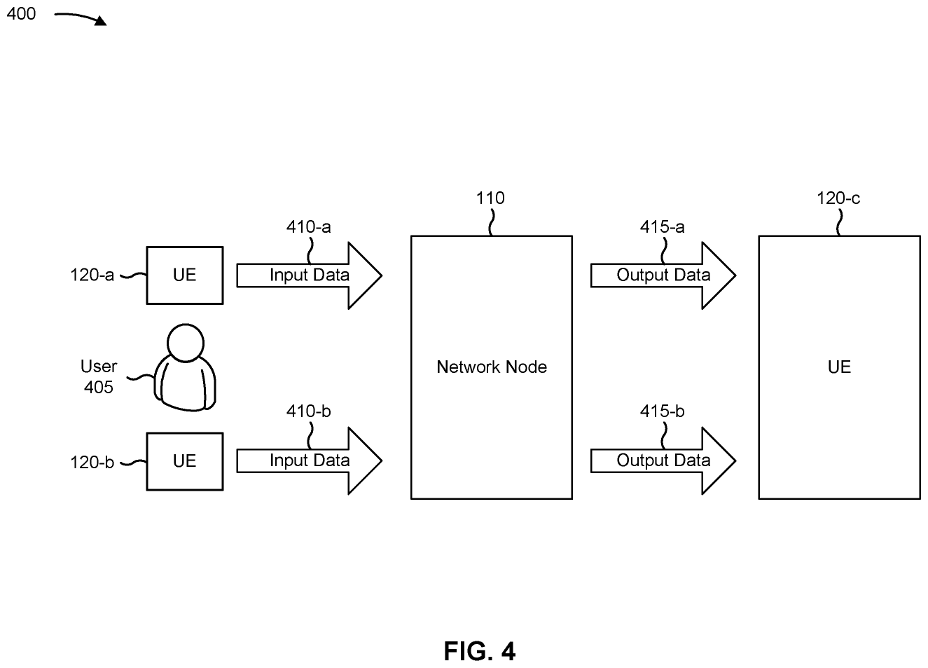

FIG. 4 is a diagram illustrating an example 400 associated with discarding multi-modal data packets, in accordance with the present disclosure. The example 400 may illustrate a multi-modal interactive system, where the UEs 120 and the network node 110 transmit or receive multi-modal data (e.g., input data 410, output data 415).

The example 400 further illustrates aspects of an immersive multi-modal virtual reality application. An immersive multi-modal virtual reality application may be associated with a case where a user 405 (e.g., a human) interacts with virtual entities in a remote environment such that the user 405 perceives interaction with a real physical world. In an example of an immersive multi-modal virtual reality application, a user 405 may be intended to perceive multiple senses (e.g., vision, sound, touch) that result in the user 405 experiencing a full immersion in the virtual environment. In some cases, the immersive multi-modal virtual reality application may rely on a tactile internet that includes a network (or a network of networks) for remotely accessing, perceiving, manipulating, or controlling real or virtual objects or processes in perceived real time by a user 405 or a machine.

In the example 400, the UEs 120 and the network node 110 may exchange data (e.g., the input data 410, the output data 415) associated with the immersive multi-modal virtual reality application.

The UEs 120-a and 120-b may include or be coupled with sensors that collect information associated with the user 405 or associated with an environment of the user 405. For example, the UEs 120-a and 120-b may include or be coupled with a microphone, a camera, a wearable device (e.g., that the user 405 is wearing such as a heartrate monitor, virtual reality glasses, gloves associated with the multi-modal virtual reality application), a thermostat, a light sensor, or another sensor that collects information associated with the user 405 or the environment of the user 405. While the UEs 120-a and 120-b are illustrated as distinct UEs 120, a single UE 120 may include both the UEs 120-a and 120-b. That is, a single UE 120 may transmit, to the network node 110, the input data 410-a and the input data 410-b.

The UEs 120-a and 120-b may transmit, and the network node 110 may receive, input data 410 that corresponds to the collected information. In an example where either of the UEs 120-a or 120-b includes or is coupled with a microphone, the input data 410 may include biometric data from a voice of the user 405, data indicating words detected from the voice of the user 405, and/or data associated with emotion detected from the voice of the user 405. Additionally, or alternatively, in an example where either of the UEs 120-a or 120-b includes or is coupled with a camera, the input data 410 may include biometric data from a face of the user 405, data associated with emotion detected from the face of the user 405, data associated with detected lip movements of the user 405, data associated with gestures detected by the camera, and/or data associated with a relative location of the user 405 that is detected by the camera. In another example, where either of the UEs 120-a or 120-b includes or is coupled with a wearable device, the input data 410 may include data associated with emotions of the user 405 detected by the wearable device, and/or haptic information associated with the user 405 that is detected by the wearable device.

The multi-modal virtual reality application may use one or more sets of multi-modal data. For example, the input data 410-a may have a multi-modal relationship with the input data 410-b. That is, sets of data packets included in the input data 410-a may have a multi-modal relationship with sets of data packets included in the input data 410-b. In one example, the input data 410 may include multi-modal data associated with natural language processing. Here, the input data 410 may include a first flow including sets of data packets associated with the data indicating words detected from the voice of the user 405, and a second flow including sets of data packets associated with the detected lip movements of the user 405. In another example, the input data 410 may include multi-modal data associated with emotions of the user 405. Here, the input data 410 may include a first flow including sets of data packets associated with the emotion detected from the voice of the user 405, a second flow including sets of data packets associated with the emotion detected from the face of the user 405, and a third flow including sets of data packets associated with the emotion of the user 405 detected by the wearable device. In another example, the input data 410 may include multi-modal data associated with haptic data. Here, the input data 410 may include a first flow including sets of data packets associated with gestures detected by the camera, and a second flow including sets of data packets associated with haptic information associated with the user 405 that is detected by the wearable device.

While the example 400 illustrates the UEs 120-a and 120-b transmitting one type of multi-modal data (e.g., including the input data 410-a and 410-b) to the network node 110, other UEs 120 (or the illustrated UEs 120-a and 120-b) may transmit additional types of multi-modal data to the network node 110.

The network node 110 may transmit (e.g., in response to receiving the input data 410), and the UE 120-c may receive, output data 415. The UE 120-c may include or be associated with an application server (e.g., associated with the immersive multi-modal virtual reality application). In some cases, the output data 415 may include multi-modal data. That is, the output data 415-a may have a multi-modal relationship with the output data 415-b, where sets of data packets included in the output data 415-a have a multi-modal relationship with the sets of data packets included in the output data 415-b. In one example, the output data 415 may include multi-modal data associated with a video. Here, the output data 415 may include a first flow including sets of data packets associated with the video data (e.g., video frames) and a second flow including sets of data packets associated with audio data. In another example, the output data 415 may include multi-modal data associated with an environment of the user 405. Here, the output data 415 may include a first flow including sets of data packets associated with a brightness of the environment (e.g., a brightness level of lights in the environment of the user 405), a second flow including sets of data packets associated with a temperature of the environment (e.g., a temperature level of the environment of the user 405), and a third flow including sets of data packets associated with a humidity of the environment (e.g., a humidity level of the environment of the user 405). In another example, the output data 415 may include haptic data. Here, the output data 415 may include a first flow including haptic data for a right-hand controller of the user 405 and a second flow including haptic data for a left-hand controller of the user 405.

In the example 400, the network node 110 is illustrated as transmitting one type of multi-modal data (e.g., including the output data 415-a and the output data 415-b) to a single UE 120. In other examples, the network node 110 may transmit more than one type of multi-modal data to more than one UE 120.

A degree of immersion achieved by an immersive multi-modal virtual reality application may indicate how real a user 405 perceives the created virtual environment to be. For example, the user 405 may perceive a more realistic created virtual environment when a higher degree of immersion is achieved by the immersive multi-modal virtual reality application, as compared to when a lower degree of immersion is achieved by the immersive multi-modal virtual reality application. Even relatively small errors in the preparation of the remote environment may be perceived by the user 405. Therefore, a high-field virtual environment (e.g., high-resolution images, 3-D stereo audio) may significantly improve a perception of the user 405 of an immersive experience.

Synchronization thresholds between different flows of output data 415 may improve a sense of presence and realism for the user 405. For example, the network node 110 may combine multiple input data 410 (e.g., coming from one UE 120 or coming from multiple UEs 120) and render the multiple input data 410 together (e.g., via the output data 415) with a close synchronization, which may create a virtual experience for the user 405 that is closer to reality (e.g., as compared to examples where the network node 110 does not render the multiple input data 410 together with the close synchronization).

However, the UEs 120 may transmit different types of input data 410 to the network node 110 according to different periodicities. That is, the UEs 120-a and 120-b may send the input data 410-a (e.g., haptic data) and the input data 410-b (e.g., sensing data) with different periodic times. In one example, the UE 120-a may send, to the network node 110, one data packet within the input data 410-a (e.g., containing haptic information) every two milliseconds, and the UE 120-b may send, to the network node 110, one data packet within the input data 410-b (e.g., related to sensing information) every four milliseconds. In this example, the haptic data and sensing data may be transferred to the network node 110 via two separate flows. Additionally, within one second the UE 120-a may generate and transfer between one thousand and four thousand data packets without haptic compression encoding (e.g., if the UE 120-a does not apply haptic compression encoding to the input data 415-a prior to transmitting the input data 415-a to the network node 110) or between one and five hundred data packets with haptic compression encoding (e.g., if the UE 120-a does apply haptic compression encoding to the input data 415-a prior to transmitting the input data 415-a to the network node 110).

Additionally, the network node 110 may transmit the output data 415 to the UE 120-c according to different periodicities. That is, the network node 110 may send the output data 415-a (e.g., haptic data, video data) and the output data 415-b (e.g., video data, audio data) with different periodicities. In one example, the network node 110 may send, to the UE 120-c, one data packet in the output data 415-a (e.g., containing haptic information, containing video data) every two milliseconds, and the network node 110 may send, to the UE 120-c, one data packet in the output data 415-b (e.g., containing a video/audio frame) every 16.7 milliseconds (e.g., in a case of 60 frames per second (fps), which corresponds to outputting one burst traffic every three milliseconds). Here, the haptic data and audio/video data may be transferred via two separate service data flows (e.g., via the output data 415-a and the output data 415-b) of one session (e.g., one PDU session).

In the example 400, the network node 110 may perform one or more operations (e.g., to render and code the output data 415) to improve a perceived reality of the immersive multi-modal virtual reality application. For example, the network node 110 may perform one or more operations to render and code video data, or audio and haptic model data, prior to transmitting the output data 415 to the UE 120-c (e.g., via periodic downlink data transmissions). The network node 110 may perform operations to generate the output data 415 that accounts for the flows of some input data 410 being predictable (e.g., such as a frame periodicity of video data) and the flows of other input data 410 being unpredictable (e.g., such as sensing data), different flows of input data 410 having different latency requirements, and a synchronization between the input data 410.

The network node 110 may rely on synchronization thresholds between the different flows of the output data 415 to improve the perceived reality of the immersive multi-modal virtual reality application. In particular, if the output data 415-a and 415-b have a multi-modal relationship, the network node 110 may configure the output data 415-a and 415-b to have a temporal relationship that is based on a synchronization threshold. For example, in some cases, a receiving device (e.g., the UE 120-c) may receive the output data 415-a within an amount of time, that is less or equal to the synchronization threshold, of receiving the output data 415-b.

The synchronization threshold may correspond to a maximum tolerable temporal separation of the UE 120-c receiving a first set of data packets within the data 415-a and a second set of data packets within the data 415-b. For example, the first set of data packets and the second set of data packets may include stimuli that are presented to different senses (or to a same sense via different inputs, such as haptic data presented to a left hand of the user 405 and haptic data presented to a right hand of the user 405), and the synchronization threshold may correspond to a maximum tolerable temporal separation of the onset of the two stimuli (e.g., to the user 405) such that the user 405 perceives the onset of the two stimuli as being synchronous (e.g., simultaneous). In one example, where the output data 415-a includes a set of haptic data packets and the output data 415-a includes a set of video data packets, the synchronization threshold for the output data 415-a and 415-b may be 15 milliseconds. That is, the UE 120-c may receive the set of haptic data packets within the output data 415-a within an amount of time that is less than or equal to 15 milliseconds of receiving the set of video data packets within the output data 415-b.

In cases where the flows associated with the input data 410 or the output data 415 include sets of data packets, a device receiving the input data 410 (e.g., the network node 110) or output data 415 (e.g., the UE 120-c) may process the sets of data packets according to a vertical relationship between sets of data packets within the flow. In one example, sets of data packets of a flow may not be related vertically. In this example, the device receiving the sets of data packets may process each set of data packets independently of other sets of data packets within the flow. In another example, sets of data packets within the flow may be related vertically. In this example, the device receiving the sets of data packets may process a set of data packets within the flow using one or more previously-received sets of data packets.

Some aspects described herein provide for the network node 110 and a UE 120 (such as the UE 120-a, the UE 120-b, and/or the UE 120-c) to select a DRX configuration from multiple configured DRX configurations. This selection may be based on traffic characteristics (such as a buffer status or a delay status) or a communication configuration (such as an active BWP or an active logical channel or flow) of the network node 110 or the UE 120. Some aspects described herein provide for the network node and the UE 120 to select a configuration for PDCCH monitoring (such as a search space set (SSS) configuration) associated with one or more of the above configurations or characteristics. It should be noted that the traffic characteristics (which may relate to transmitted communications of the UE 120) can provide an indication of a suitable SSS configuration since it is expected that uplink conditions are related to downlink conditions at the UE 120.

As indicated above, FIG. 4 is provided as an example. Other examples may differ from what is described with respect to FIG. 4.

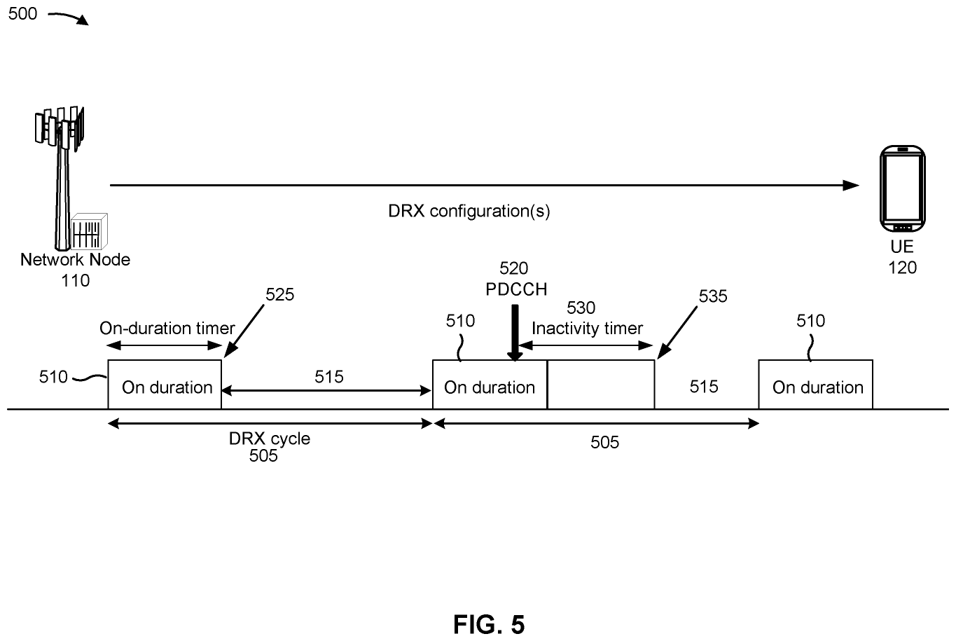

FIG. 5 is a diagram illustrating an example 500 of a discontinuous reception (DRX) configuration, in accordance with the present disclosure.

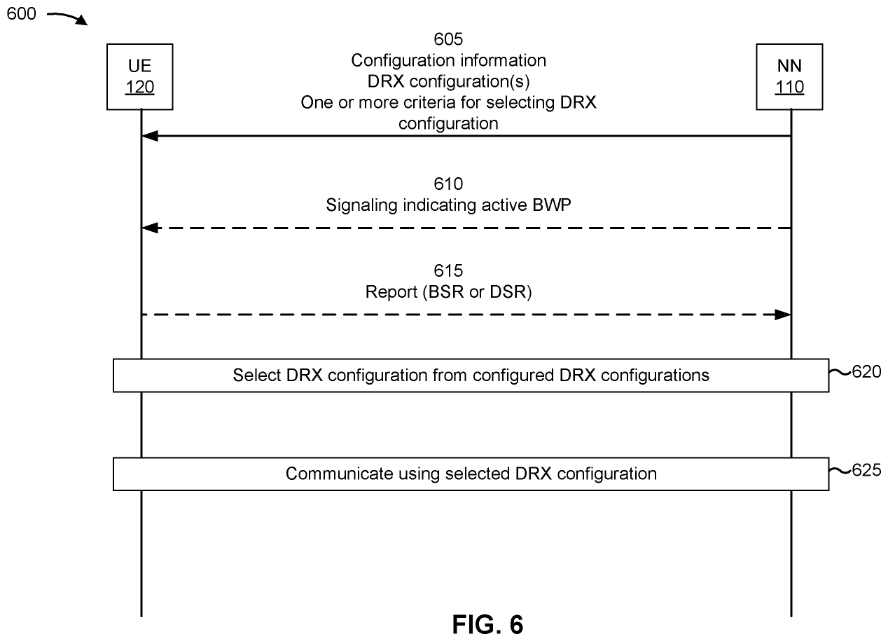

As shown in FIG. 5, a network node 110 may transmit a DRX configuration to a UE 120 to configure a DRX cycle 505 for the UE 120. In some aspects, the network node 110 may transmit multiple DRX configurations, each corresponding to a different DRX cycle 505. For example, a DRX configuration may include an indication of a DRX on duration 510, a DRX cycle length, and/or a length of an inactivity timer 530. One or more of these parameters may differ from DRX configuration to DRX configuration. In some aspects, the network node 110 may configure one or more criteria for selecting a DRX configuration (and thus a corresponding DRX cycle 505) from the multiple configured DRX configurations, as described in connection with FIG. 6.

A DRX cycle 505 may include a DRX on duration 510 (e.g., during which a UE 120 is awake or in an active state) and an opportunity to enter a DRX sleep state 515. As used herein, the time during which the UE 120 is configured to be in an active state during the DRX on duration 510 may be referred to as an active time, and the time during which the UE 120 is configured to be in the DRX sleep state 515 may be referred to as an inactive time. As described below, the UE 120 may monitor a physical downlink control channel (PDCCH) during the active time, and may refrain from monitoring the PDCCH during the inactive time.

During the DRX on duration 510 (e.g., the active time), the UE 120 may monitor a downlink control channel (e.g., a PDCCH), as shown by reference number 520. For example, the UE 120 may monitor the PDCCH for downlink control information (DCI) pertaining to the UE 120. If the UE 120 does not detect and/or successfully decode any PDCCH communications intended for the UE 120 during the DRX on duration 510, then the UE 120 may enter the sleep state 515 (e.g., for the inactive time) at the end of the DRX on duration 510, as shown by reference number 525. In this way, the UE 120 may conserve battery power and reduce power consumption. As shown, the DRX cycle 505 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 530 (e.g., which may extend the active time). The UE 120 may start the DRX inactivity timer 530 at a time at which the PDCCH communication is received (e.g., in a transmission time interval (TTI) in which the PDCCH communication is received, such as a slot or a subframe). The UE 120 may remain in the active state until the DRX inactivity timer 530 expires, at which time the UE 120 may enter the sleep state 515 (e.g., for the inactive time), as shown by reference number 535. During the duration of the DRX inactivity timer 530, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 530 after each detection of a PDCCH communication for the UE 120 for an initial transmission (e.g., but not for a retransmission). By operating in this manner, the UE 120 may conserve battery power and reduce power consumption by entering the sleep state 515.

As indicated above, FIG. 5 is provided as an example. Other examples may differ from what is described with respect to FIG. 5.

FIG. 6 is a diagram illustrating an example 600 of selecting from multiple DRX configurations, such as for multi-modal data communication, in accordance with the present disclosure. Example 600 includes a UE 120 (e.g., the UE 120-a, 120-b, or 120-c of FIG. 4) and a network node 110. In some aspects, the UE 120 and the network node 110 may communicate in association with multi-modal data. For example, the UE 120 and the network node 110 may exchange information associated with an application server for an XR application involving multi-modal data.

As shown by reference number 605, the network node 110 may transmit, and the UE 120 may receive, configuration information. For example, the network node 110 may transmit the configuration information via RRC signaling, MAC signaling, DCI, or a combination thereof.

In some aspects, the configuration information may include one or more DRX configurations. For example, the network node 110 may configure the one or more DRX configurations for the UE 120. In some aspects, the one or more DRX configurations may include a plurality of DRX configurations corresponding to a plurality of DRX cycles. As just one example, the configuration information may configure the following DRX cycles: DRX 1=ON 5 ms, Inactivity 5 ms, Cycle 20 ms; DRX 2=ON 3 ms, Inactivity 1 ms, Cycle 10 ms; DRX 3=ON 10 ms, Inactivity 10 ms, Cycle 40 ms. These example DRX cycles are referred to below as “DRX 1,” “DRX 2,” and “DRX 3.” In some aspects, a DRX configuration may indicate a DRX on duration, an inactivity timer length, a DRX cycle length, a starting offset, or a combination thereof. It should be noted that a DRX configuration can include deactivated DRX. For example, the UE 120 may select a DRX configuration that indicates to deactivate a DRX cycle (e.g., to continuously monitor for a PDCCH).

In some aspects, the configuration information may indicate one or more criteria. For example, the configuration information may include a configuration of the one or more criteria. The UE 120 and the network node 110 may use the one or more criteria to select a DRX configuration from one or more configured DRX configurations. Example criteria are described below.

In some aspects, the configuration information may indicate a buffer status threshold (e.g., the one or more criteria may include a buffer status threshold). The buffer status threshold may indicate a buffer size (e.g., a total buffer size, such as 50 KB). The UE 120 may compare a buffer size and the buffer status threshold. When a buffer size of the UE 120 (for example, as indicated by a BSR transmitted by the UE 120) fails to satisfy the buffer status threshold, the configuration information may indicate to use a first DRX configuration (e.g., DRX 2). When the buffer size satisfies the buffer status threshold, the configuration information may indicate to use a second DRX configuration (e.g., DRX 1). Thus, for example, when the total buffer size is less than the buffer status threshold, a DRX cycle suitable to haptic traffic may be used, whereas when the total buffer size is greater than the buffer status threshold, a DRX cycle suitable to video traffic may be used. When the UE 120 transmits the BSR MAC-CE in the uplink for one or more different logical channel groups (LCG), the UE 120 may switch to a selected DRX configuration based on the reported BSR (e.g., in accordance with the buffer status threshold).

In some aspects, the configuration information may indicate a delay status threshold (e.g., the one or more criteria may include a delay status threshold). For example, the configuration information may indicate a mapping between a DSR value (e.g., a delay) and a DRX configuration (e.g., if a reported DSR is less than a configured delay status threshold, then use DRX 1, and when at least one LCG reports a DSR greater than the delay status threshold, then operate with DRX 2). The delay status threshold may indicate a delay (e.g., an uplink delay). The UE 120 may compare a delay and the delay status threshold. When a delay of the UE 120 (for example, as indicated by a DSR transmitted by the UE 120) satisfies the delay status threshold, the configuration information may indicate to use a first DRX configuration. When the delay of the UE 120 fails to satisfy the delay status threshold, the configuration information may indicate to use a second DRX configuration. Thus, when the experienced uplink delay reported using a DSR indicates an intolerable delay in the uplink, the UE 120 may switch DRX configurations to use a shorter DRX cycle. With a shorter DRX cycle, the UE 120 has a higher chance of receiving downlink and uplink grants. Additionally, or alternatively, the UE 120 can operate with no DRX cycle (e.g., a deactivated DRX configuration) until all reported delays for multiple logical channels are below the delay status threshold. Thus, the UE 120 may deactivate a DRX cycle in association with the delay status threshold being satisfied.

In some aspects, the configuration information may indicate a power consumption threshold (e.g., the one or more criteria may include a power consumption threshold). For example, the power consumption threshold may indicate a transmit power threshold of the UE 120 (e.g., an uplink transmit power threshold, a maximum transmit power threshold, a threshold for a transmitted amount of energy, or the like). The UE 120 may transmit a communication at a transmit power, and may compare the transmit power and the power consumption threshold. When the transmit power of the UE 120 satisfies the power consumption threshold (such as the transmit power threshold), the configuration information may indicate to use (e.g., communicate in accordance with) a first DRX configuration (for example, a DRX configuration associated with lower power consumption). When a transmit power of the UE 120 fails to satisfy the power consumption threshold, the configuration information may indicate to use (e.g., communicate in accordance with) a second DRX configuration (for example, a DRX configuration associated with lower power consumption). In some aspects, the UE 120 may have information indicating the power consumption threshold (e.g., in the absence of configuration information indicating the power consumption threshold). In some aspects, the UE 120 may transmit, to the network node 110, an indication of which DRX configuration is selected. For example, the UE 120 may transmit dynamic signaling that indicates the selected DRX configuration, which enables symmetric operation between the UE 120 and the network node 110 even if the UE 120 does not explicitly report the transmit power.

In some aspects, the configuration information may indicate an active BWP condition (e.g., the one or more criteria may include an active BWP condition). For example, the configuration information may indicate one or more DRX configurations that are mapped to a BWP. Once the BWP is activated (such as via DCI), the UE 120 may select a DRX configuration of the one or more DRX configurations. For example, the UE 120 may use a single DRX configuration that is configured as mapped to the BWP. As another example, the UE 120 may select a DRX configuration of multiple DRX configurations mapped to the BWP (such as using the one or more criteria). Thus, BWP-specific DRX configuration may be implemented, which may provide power savings for BWP switching. For example, a higher throughput traffic (such as a burst type of traffic) might use a larger bandwidth BWP and DRX 3, whereas a lower throughput traffic might use a smaller bandwidth BWP and DRX 1.

In some aspects, the configuration information may indicate a logical channel or flow based mapping of a DRX configuration. For example, a first logical channel, quality of service (QoS) flow identifier (QFI), or flow information may be mapped to a first DRX configuration and a second logical channel, QFI, or flow information may be mapped to a second DRX configuration. When communicating (or scheduled to communicate) using the first logical channel, QFI, or flow information, the UE 120 and the network node 110 may select the first DRX configuration. When communicating (or scheduled to communicate) using the second logical channel, QFI, or flow information, the UE 120 and the network node 110 may select the second DRX configuration.

As shown by reference number 610, in some aspects, the network node 110 may transmit, and the UE 120 may receive, signaling that indicates an active BWP. For example, the signaling may include DCI indicating to switch to the active BWP. In some aspects (e.g., when the one or more criteria configured at reference number 605 include an active BWP condition), the UE 120 and the network node 110 may select a DRX configuration according to the signaling, as described below.

As shown by reference number 615, in some aspects, the UE 120 may transmit, and the network node 110 may receive, a report. The report may include a BSR or a DSR, among other examples. In some aspects (e.g., when the one or more criteria configured at reference number 605 include a buffer status threshold and/or a delay status threshold), the UE 120 and the network node 110 may select a DRX configuration according to the report, as described below.

As shown by reference number 620, the network node 110 and the UE 120 may select a DRX configuration from the configured DRX configurations. For example, the UE 120 may select the DRX configuration according to the one or more criteria. As another example, the network node 110 may select the DRX configuration according to the one or more criteria. The one or more criteria may include any combination of a logical channel/QFI/flow information mapping, a buffer status threshold, a delay status threshold, a power consumption threshold, or an active BWP condition, as described above. In some aspects, the network node 110 may select the DRX configuration according to signaling transmitted by and received from the UE 120, such as a BSR, a DSR, an indication of a selected DRX configuration, or an indication of a transmit power of the UE 120.

As shown by reference number 625, the UE 120 and the network node 110 may communicate using the selected DRX configuration. For example, the UE 120 may monitor for a PDCCH during a DRX on duration defined by the selected DRX configuration, and may use an inactivity timer defined by the selected DRX configuration. The UE 120 may monitor for the PDCCH according to a DRX cycle length indicated by the selected DRX configuration. As another example, the network node 110 may transmit a PDCCH during a DRX on duration defined by the selected DRX configuration. The network node 110 may transmit the PDCCH according to a DRX cycle length indicated by the selected DRX configuration.

As indicated above, FIG. 6 is provided as an example. Other examples may differ from what is described with regard to FIG. 6.

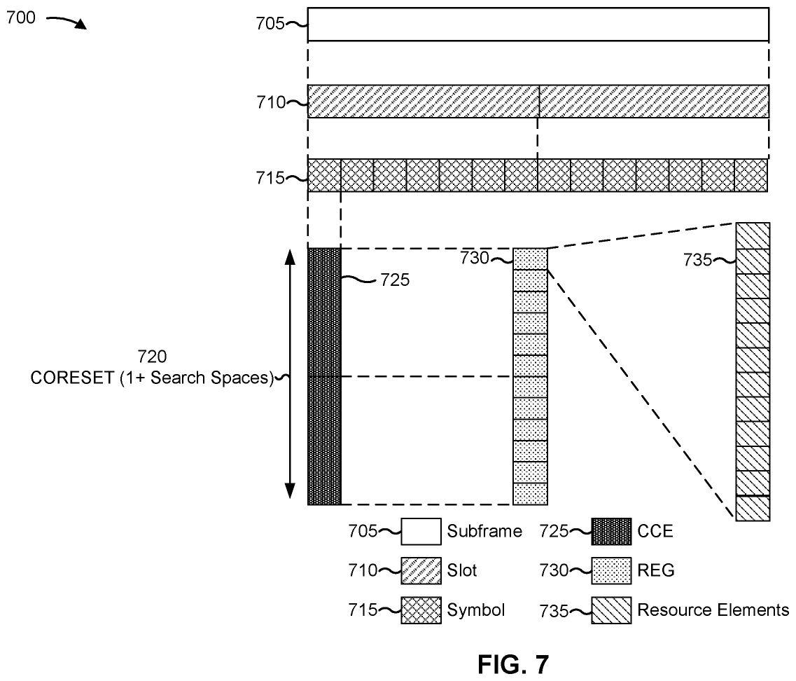

FIG. 7 is a diagram illustrating an example resource structure 700 for wireless communication, in accordance with the present disclosure. Resource structure 700 shows an example of various groups of resources described herein. As shown, resource structure 700 may include a subframe 705. Subframe 705 may include multiple slots 710. While resource structure 700 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 710 may include multiple symbols 715, such as 14 symbols per slot.

The potential control region of a slot 710 may be referred to as a control resource set (CORESET) 720 and may be structured to support an efficient use of resources, such as by flexible configuration or reconfiguration of resources of the CORESET 720 for one or more PDCCHs and/or one or more physical downlink shared channels (PDSCHs). In some aspects, the CORESET 720 may occupy the first symbol 715 of a slot 710, the first two symbols 715 of a slot 710, or the first three symbols 715 of a slot 710. Thus, a CORESET 720 may include multiple resource blocks (RBs) in the frequency domain, and either one, two, or three symbols 715 in the time domain. A quantity of resources included in the CORESET 720 may be flexibly configured, such as by using radio resource control (RRC) signaling to indicate a frequency domain region (e.g., a quantity of resource blocks) and/or a time domain region (e.g., a quantity of symbols) for the CORESET 720.

As illustrated, a symbol 715 that includes CORESET 720 may include one or more control channel elements (CCEs) 725, shown as two CCEs 725 as an example, that span a portion of the system bandwidth. A CCE 725 may include DCI that is used to provide control information for wireless communication. A network node may transmit DCI during multiple CCEs 725 (as shown), where the quantity of CCEs 725 used for transmission of DCI represents the aggregation level (AL) used by the network node for the transmission of DCI. In FIG. 7, an aggregation level of two is shown as an example, corresponding to two CCEs 725 in a slot 710. In some aspects, different aggregation levels may be used, such as 1, 2, 4, 8, 16, or another aggregation level.

Each CCE 725 may include a fixed quantity of resource element groups (REGs) 730, shown as 6 REGs 730, or may include a variable quantity of REGs 730. In some aspects, the quantity of REGs 730 included in a CCE 725 may be specified by a REG bundle size. A REG 730 may include one resource block, which may include 12 resource elements (REs) 735 within a symbol 715. A resource element 735 may occupy one subcarrier in the frequency domain and one OFDM symbol in the time domain.

A search space may include all possible locations (e.g., in time and/or frequency) where a PDCCH may be located. A CORESET 720 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set (SSS). In some aspects, a UE may be configured with a group of SSSs, referred to as an SSS group (SSSG).

A CORESET 720 may be interleaved or non-interleaved. An interleaved CORESET 720 may have CCE-to-REG mapping such that adjacent CCEs are mapped to scattered REG bundles in the frequency domain (e.g., adjacent CCEs are not mapped to consecutive REG bundles of the CORESET 720). A non-interleaved CORESET 720 may have a CCE-to-REG mapping such that all CCEs are mapped to consecutive REG bundles (e.g., in the frequency domain) of the CORESET 720.

As indicated above, FIG. 7 is provided as an example. Other examples may differ from what is described with respect to FIG. 7.

As mentioned, reducing the amount of time or resources spent on monitoring the PDCCH may reduce power consumption of the UE. For example, in some situations, it may be beneficial to switch to an SSS or SSSG configuration associated with a lower amount of time or resources for PDCCH monitoring, such as when traffic is expected to be sparse or small. Thus, switching between multiple different SSS or SSSG configurations may be beneficial in the context of multi-modal data communication. For example, a first SSS or SSSG configuration may provide suitable performance for video traffic and a second SSS or SSSG configuration may provide suitable performance for haptic data. However, if the UE and the network do not have information indicating a currently active SSS or SSSG configuration at the UE, the benefits of the SSS or SSSG configuration for reduction of power consumption may be reduced or eliminated. Furthermore, explicitly signaling configuration information to configure the currently active SSS or SSSG configuration may be associated with overhead and latency.

Various aspects relate generally to switching between multiple configured SSS or SSSG configurations. Some aspects more specifically relate to switching between SSS or SSSG configurations according to dynamic conditions or traffic at a UE. In some aspects, a UE may be configured with a plurality of SSS or SSSG configurations. The UE may communicate in accordance with a selected SSS or SSSG configuration of the plurality of the DRX configurations. For example, the selected SSS or SSSG configuration may be associated with a buffer status threshold, a delay status threshold, a power consumption threshold, or an active bandwidth part (BWP) of the UE. As one example, the UE may transmit a buffer status report (BSR), and may select the selected SSS or SSSG configuration in accordance with the buffer status threshold and the BSR. As another example, the UE may transmit a delay status report (DSR), and may select the selected SSS or SSSG configuration in accordance with the delay status threshold and the DSR. As yet another example, the UE may select the selected SSS or SSSG configuration in accordance with the power consumption threshold, and may transmit an indication of the selected SSS or SSSG configuration. As still another example, the UE may receive signaling that indicates the active BWP, and may select the selected SSS or SSSG configuration based on an association between the SSS or SSSG configuration and the active BWP.

Particular aspects of the subject matter described in this disclosure can be implemented to realize one or more of the following potential advantages. In some examples, by selecting the SSS or SSSG configuration based on one or more of the above criteria, the described techniques can be used to select between different SSS or SSSG cycles, which may be suitable for different types of single-modal data or different synchronization thresholds. Thus, conformance with synchronization thresholds may be achieved while decreasing power consumption and network energy consumption.

Selecting the selected SSS or SSSG configuration in accordance with the buffer status threshold may provide selection of the SSS or SSSG configuration based on an amount of buffered data, which may provide for a shorter on duration or inactivity timer for low-data modes (e.g., haptic data) and a longer on duration or inactivity timer for high-data modes (e.g., video data). Furthermore, the BSR may provide the network with an indication of the amount of buffered data, enabling symmetric operation. Selecting the selected SSS or SSSG configuration in accordance with the delay status threshold may provide selection of the DRX configuration based on an amount of observed delay, which enables switching to a more aggressive SSS or SSSG cycle. Furthermore, the DSR may provide the network with an indication of the delay, enabling symmetric operation.

Selecting the selected SSS or SSSG configuration in accordance with the power consumption threshold may enable power saving when power consumption of the UE (or transmit power of the UE, or the like) exceeds a threshold. In this example, transmitting an indication of the selected SSS or SSSG configuration may enable the network to operate symmetrically with the UE. Selecting the selected SSS or SSSG configuration in accordance with the active BWP enables the UE to use a suitable SSS or SSSG configuration for a given BWP, which may also be a suitable SSS or SSSG configuration given traffic conditions at the UE (since the active BWP may be selected based on traffic patterns (e.g., BSR, latency) or radio characteristics (e.g., block error rate, cell loading). Thus, selecting from multiple SSS or SSSG configurations based on the active BWP or the traffic characteristics gives better key performance indicators in terms of the throughput, block error rate (BLER), and latency, by ensuring that synchronous flows are addressed to meet the multi-modal traffic requirements for immersive XR.

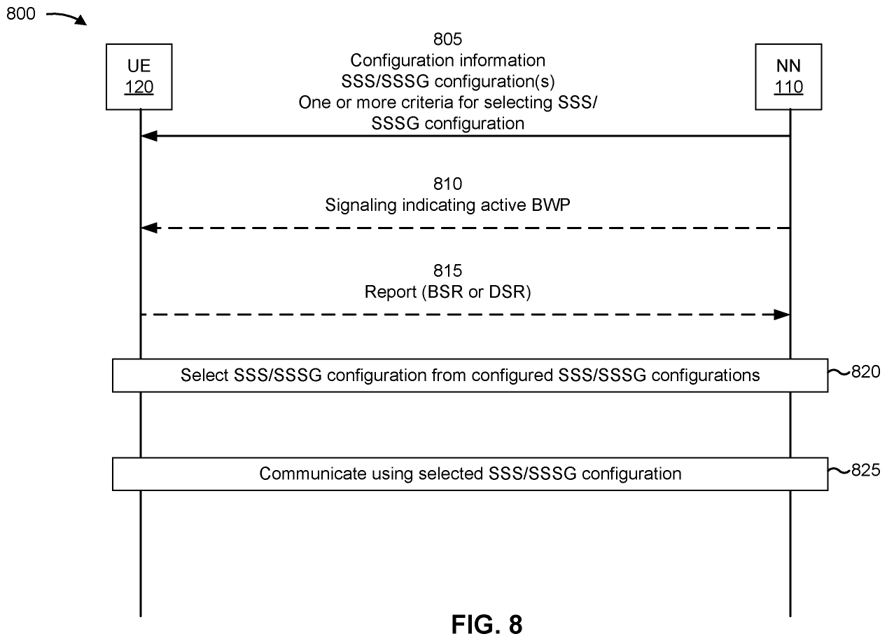

FIG. 8 is a diagram illustrating an example 800 of PDCCH monitoring variation based on a BWP or DRX configuration, in accordance with the present disclosure. Example 800 includes a UE 120 (e.g., the UE 120-a, 120-b, or 120-c of FIG. 4) and a network node 110. In some aspects, the UE 120 and the network node 110 may communicate in association with multi-modal data. For example, the UE 120 and the network node 110 may exchange information associated with an application server for an XR application involving multi-modal data.

As shown by reference number 805, the network node 110 may transmit, and the UE 120 may receive, configuration information. For example, the network node 110 may transmit the configuration information via RRC signaling, MAC signaling, DCI, or a combination thereof.

In some aspects, the configuration information may include one or more SSS or SSSG configurations. For example, the network node 110 may configure the one or more SSS or SSSG configurations for the UE 120. In some aspects, the one or more SSS or SSSG configurations may include a plurality of SSS or SSSG configurations. In some aspects, the configuration information may indicate one or more criteria. The UE 120 and the network node 110 may use the one or more criteria to select an SSS or SSSG configuration from one or more configured SSS or SSSG configurations. Example criteria are described herein. An SSS or SSSG configuration may define an SSS and/or an SSSG. For example, an SSS or SSSG configuration may indicate one or more SSs, a monitoring periodicity, an offset, one or more symbols of an SS, or the like.

In some aspects, the configuration information may indicate a buffer status threshold (e.g., the one or more criteria may include a buffer status threshold). The buffer status threshold may indicate a buffer size (e.g., a total buffer size, such as 50 KB). The UE 120 may compare a buffer size and the buffer status threshold. When a buffer size of the UE 120 (for example, as indicated by a BSR transmitted by the UE 120) fails to satisfy the buffer status threshold, the configuration information may indicate to use a first SSS or SSSG configuration. When the buffer size satisfies the buffer status threshold, the configuration information may indicate to use a second SSS or SSSG configuration. Thus, for example, when the total buffer is less than the buffer status threshold, an SSS or SSSG configuration suitable to haptic traffic may be used, whereas when the total buffer is greater than the buffer status threshold, an SSS or SSSG configuration suitable to video traffic may be used. When the UE 120 transmits the BSR MAC-CE in the uplink for one or more different logical channel groups (LCGs), the UE 120 may switch to a selected SSS or SSSG configuration based on the reported BSR (e.g., in accordance with the buffer status threshold).

In some aspects, the configuration information may indicate a delay status threshold (e.g., the one or more criteria may include a delay status threshold). For example, the configuration information may indicate a mapping between a DSR value (e.g., a delay) and an SSS or SSSG configuration (e.g., if a reported DSR is less than a configured delay status threshold, then use SSS 1, and when at least one LCG reports a DSR greater than the delay status threshold, then use SSS 2). The delay status threshold may indicate a delay (e.g., an uplink delay). The UE 120 may compare a delay and the delay status threshold. When a delay of the UE 120 (for example, as indicated by a DSR transmitted by the UE 120) satisfies the delay status threshold, the configuration information may indicate to use a first SSS or SSSG configuration. When the delay of the UE 120 fails to satisfy the delay status threshold, the configuration information may indicate to use a second SSS or SSSG configuration. Thus, when the experienced uplink delay reported using a DSR indicates an intolerable delay in the uplink, the UE 120 may switch SSS or SSSG configurations to use a shorter monitoring periodicity. With a shorter monitoring periodicity cycle, the UE 120 has a higher chance of receiving downlink and uplink grants.

In some aspects, the configuration information may indicate a power consumption threshold (e.g., the one or more criteria may include a power consumption threshold). For example, the power consumption threshold may indicate a transmit power threshold of the UE 120 (e.g., an uplink transmit power threshold, a maximum transmit power threshold, a threshold for a transmitted amount of energy, or the like). The UE 120 may transmit a communication at a transmit power, and may compare the transmit power and the power consumption threshold. When the transmit power of the UE 120 satisfies the power consumption threshold (for example, the transmit power threshold), the configuration information may indicate to use (e.g., communicate in accordance with) a first SSS or SSSG configuration (for example, an SSS or SSSG configuration associated with lower power consumption). When a transmit power of the UE 120 fails to satisfy the power consumption threshold, the configuration information may indicate to use (e.g., communicate in accordance with) a second SSS or SSSG configuration (for example, an SSS or SSSG configuration associated with lower power consumption). In some aspects, the UE 120 may have information indicating the power consumption threshold (e.g., in the absence of configuration information indicating the power consumption threshold). In some aspects, the UE 120 may transmit, to the network node 110, an indication of which SSS or SSSG configuration is selected. For example, the UE 120 may transmit dynamic signaling that indicates the selected SSS or SSSG configuration, which enables symmetric operation between the UE 120 and the network node 110 even if the UE 120 does not explicitly report the transmit power.

In some aspects, the configuration information may indicate an active BWP condition (e.g., the one or more criteria may include an active BWP condition). For example, the configuration information may indicate one or more SSS or SSSG configurations that are mapped to a BWP. Once the BWP is activated (such as via DCI), the UE 120 may select an SSS or SSSG configuration of the one or more SSS or SSSG configurations. For example, the UE 120 may use a single SSS or SSSG configuration that is configured as mapped to the BWP. As another example, the UE 120 may select an SSS or SSSG configuration of multiple SSS or SSSG configurations mapped to the BWP (such as using the one or more criteria). Thus, BWP-specific SSS or SSSG configuration may be implemented, which may provide power savings for BWP switching.

In some aspects, the configuration information may indicate a logical channel or flow based mapping of an SSS or SSSG configuration. For example, a first logical channel, quality of service (QoS) flow identifier (QFI), or flow information may be mapped to a first SSS or SSSG configuration and a second logical channel, QFI, or flow information may be mapped to a second SSS or SSSG configuration. When communicating (or scheduled to communicate) using the first logical channel, QFI, or flow information, the UE 120 and the network node 110 may select the first SSS or SSSG configuration. When communicating (or scheduled to communicate) using the second logical channel, QFI, or flow information, the UE 120 and the network node 110 may select the second SSS or SSSG configuration.

In some aspects, the configuration information may indicate a DRX configuration condition (e.g., the one or more criteria may include a DRX configuration condition). For example, the configuration information may indicate one or more SSS or SSSG configurations that are mapped to a DRX configuration. Once the DRX configuration is activated (such as via RRC signaling, or based on being selected by the UE 120), the UE 120 may select an SSS or SSSG configuration of the one or more SSS or SSSG configurations. For example, the UE 120 may use a single SSS or SSSG configuration that is configured as mapped to the DRX configuration. As another example, the UE 120 may select an SSS or SSSG configuration of multiple SSS or SSSG configurations mapped to the DRX configuration (such as using the one or more criteria). Thus, DRX-specific SSS or SSSG configuration may be implemented. In this context, a DRX configuration may be considered active if the UE 120 is communicating in accordance with a DRX cycle defined by the DRX configuration.

As shown by reference number 810, in some aspects, the network node 110 may transmit, and the UE 120 may receive, signaling that indicates an active BWP. For example, the signaling may include DCI indicating to switch to the active BWP. In some aspects (when the one or more criteria configured at reference number 805 include an active BWP condition), the UE 120 and the network node 110 may select an SSS or SSSG configuration according to the signaling, as described below.

As shown by reference number 815, in some aspects, the UE 120 may transmit, and the network node 110 may receive, a report. The report may include a BSR or a DSR, among other examples. In some aspects (when the one or more criteria configured at reference number 805 include a buffer status threshold and/or a delay status threshold), the UE 120 and the network node 110 may select an SSS or SSSG configuration according to the report, as described below.

As shown by reference number 820, the network node 110 and the UE 120 may select an SSS or SSSG configuration from the one or more configured SSS or SSSG configurations. For example, the UE 120 may select the SSS or SSSG configuration according to the one or more criteria. As another example, the network node 110 may select the SSS or SSSG configuration according to the one or more criteria. The one or more criteria may include any combination of a logical channel/QFI/flow information mapping, a buffer status threshold, a delay status threshold, a power consumption threshold, an active DRX configuration condition, or an active BWP condition, as described above. In some aspects, the network node 110 may select the SSS or SSSG configuration according to signaling transmitted by and received from the UE 120, such as a BSR, a DSR, an indication of a selected DRX configuration, or an indication of a transmit power of the UE 120.

As shown by reference number 825, the UE 120 and the network node 110 may communicate using the selected SSS or SSSG configuration. For example, the UE 120 may monitor for a PDCCH in one or more SSs defined by the selected SSS or SSSG configuration. As another example, the network node 110 may transmit a PDCCH in an SS defined by the selected SSS or SSSG configuration.

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with selecting from multiple DRX configurations.

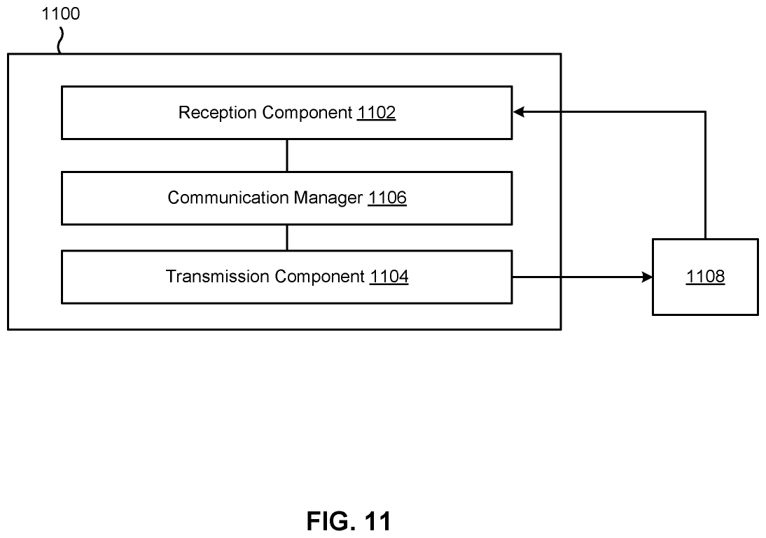

As shown in FIG. 9, in some aspects, process 900 may include receiving configuration information indicating a plurality of DRX configurations (block 910). For example, the UE (e.g., using reception component 1102 and/or communication manager 1106, depicted in FIG. 11) may receive configuration information indicating a plurality of DRX configurations, as described above, for example, in connection with reference number 605 of FIG. 6.

As further shown in FIG. 9, in some aspects, process 900 may include communicating in accordance with a selected DRX configuration of the plurality of DRX configurations, wherein the selected DRX configuration is associated with one or more criteria (block 920). For example, the UE (e.g., using reception component 1102, transmission component 1104, and/or communication manager 1106, depicted in FIG. 11) may communicate in accordance with a selected DRX configuration of the plurality of DRX configurations. The selected DRX configuration may be associated with one or more criteria comprising at least one of: a buffer status threshold, a delay status threshold, a power consumption threshold, or an active bandwidth part condition of the UE, as described above, for example, in connection with reference number 625 of FIG. 6.

Process 900 may include additional aspects, such as any single aspect or any combination of aspects described below and/or in connection with one or more other processes described elsewhere herein.

In a first aspect, the one or more criteria comprise the buffer status threshold.

In a second aspect, alone or in combination with the first aspect, process 900 includes communicating in accordance with the selected DRX configuration based on comparing the buffer status threshold and a buffer status indicated by the buffer status report.

In a third aspect, alone or in combination with one or more of the first and second aspects, the one or more criteria comprise the delay status threshold.

In a fourth aspect, alone or in combination with one or more of the first through third aspects, process 900 includes communicating in accordance with the selected DRX configuration based on comparing the delay status threshold and a delay status indicated by the delay status report.

In a fifth aspect, alone or in combination with one or more of the first through fourth aspects, the selected DRX configuration is a deactivated DRX configuration in which a DRX cycle is deactivated in association with the delay status threshold being satisfied.

In a sixth aspect, alone or in combination with one or more of the first through fifth aspects, process 900 includes transmitting an indication of the selected DRX configuration.

In a seventh aspect, alone or in combination with one or more of the first through sixth aspects, the one or more criteria comprise the power consumption threshold.

In an eighth aspect, alone or in combination with one or more of the first through seventh aspects, the power consumption threshold is a transmit power threshold of the UE.

In a ninth aspect, alone or in combination with one or more of the first through eighth aspects, the one or more criteria comprise the active bandwidth part condition, wherein the active bandwidth part condition indicates that the selected DRX configuration is associated with an active bandwidth part of the UE.

In a tenth aspect, alone or in combination with one or more of the first through ninth aspects, process 900 includes receiving signaling that indicates the active bandwidth part.

In an eleventh aspect, alone or in combination with one or more of the first through tenth aspects, process 900 includes receiving a configuration of the one or more criteria.

In a twelfth aspect, alone or in combination with one or more of the first through eleventh aspects, process 900 includes selecting the selected DRX configuration in accordance with the one or more criteria.

In a thirteenth aspect, alone or in combination with one or more of the first through twelfth aspects, selecting the selected DRX configuration further comprises selecting the selected DRX configuration in accordance with the one or more criteria and at least one of a logical channel or a quality of service flow.

In a fourteenth aspect, alone or in combination with one or more of the first through thirteenth aspects, selecting the selected DRX configuration further comprises selecting the selected DRX configuration in accordance with two or more of the buffer status threshold, the delay status threshold, the power consumption threshold, or the active bandwidth part condition.

In a fifteenth aspect, alone or in combination with one or more of the first through fourteenth aspects, communicating using the selected DRX configuration comprises monitoring for a physical downlink control channel in accordance with at least one of an on duration, an inactivity timer, or a cycle length defined by the selected DRX configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with selecting from multiple SSS or SSSG configurations.

As shown in FIG. 10, in some aspects, process 1000 may include receiving configuration information indicating a plurality of SSS or SSSG configurations (block 1010). For example, the UE (e.g., using reception component 1102 and/or communication manager 1106, depicted in FIG. 11) may receive configuration information indicating a plurality of SSS or SSSG configurations, as described above, for example, in connection with reference number 805 of FIG. 8.

As further shown in FIG. 10, in some aspects, process 1000 may include communicating in accordance with a selected SSS or SSSG configuration of the plurality of SSS or SSSG configurations, wherein the selected SSS or SSSG configuration is associated with one or more criteria (block 1020). For example, the UE (e.g., using reception component 1102, transmission component 1104, and/or communication manager 1106, depicted in FIG. 11) may communicate in accordance with a selected SSS or SSSG configuration of the plurality of SSS or SSSG configurations. The selected SSS or SSSG configuration may be associated with one or more criteria comprising at least one of: a buffer status threshold, a delay status threshold, a power consumption threshold, a DRX configuration condition, or an active bandwidth part condition of the UE, as described above, for example, in connection with reference number 825 of FIG. 8.

Process 1000 may include additional aspects, such as any single aspect or any combination of aspects described below and/or in connection with one or more other processes described elsewhere herein.

In a first aspect, the one or more criteria comprise the buffer status threshold.

In a second aspect, alone or in combination with the first aspect, process 1000 includes communicating in accordance with the selected SSS or SSSG configuration based on comparing the buffer status threshold and a buffer status indicated by the buffer status report.

In a third aspect, alone or in combination with one or more of the first and second aspects, the one or more criteria comprise the delay status threshold.

In a fourth aspect, alone or in combination with one or more of the first through third aspects, process 1000 includes communicating in accordance with the selected SSS or SSSG configuration based on comparing the delay status threshold and a delay status indicated by the delay status report.

In a fifth aspect, alone or in combination with one or more of the first through fourth aspects, process 1000 includes transmitting an indication of the selected SSS or SSSG configuration.

In a sixth aspect, alone or in combination with one or more of the first through fifth aspects, the one or more criteria comprise the power consumption threshold.

In a seventh aspect, alone or in combination with one or more of the first through sixth aspects, the power consumption threshold is a threshold for a transmit power of the UE.

In an eighth aspect, alone or in combination with one or more of the first through seventh aspects, the one or more criteria comprise the active bandwidth part condition, wherein the active bandwidth part condition indicates that the selected SSS or SSSG configuration is associated with an active bandwidth part of the UE.

In a ninth aspect, alone or in combination with one or more of the first through eighth aspects, process 1000 includes receiving signaling that indicates the active bandwidth part.

In a tenth aspect, alone or in combination with one or more of the first through ninth aspects, process 1000 includes receiving a configuration of the one or more criteria.

In an eleventh aspect, alone or in combination with one or more of the first through tenth aspects, process 1000 includes selecting the selected SSS or SSSG configuration in accordance with the one or more criteria.

In a twelfth aspect, alone or in combination with one or more of the first through eleventh aspects, selecting the selected SSS or SSSG configuration further comprises selecting the selected SSS or SSSG configuration in accordance with the one or more criteria and at least one of a logical channel or a quality of service flow.

In a thirteenth aspect, alone or in combination with one or more of the first through twelfth aspects, selecting the selected SSS or SSSG configuration further comprises selecting the selected SSS or SSSG configuration in accordance with two or more of the buffer status threshold, the delay status threshold, the power consumption threshold, or the active bandwidth part condition.

In a fourteenth aspect, alone or in combination with one or more of the first through thirteenth aspects, communicating in accordance with the selected SSS or SSSG configuration comprises monitoring for a physical downlink control channel in one or more search spaces defined by the selected SSS or SSSG configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 3-8. Additionally, or alternatively, the apparatus 1100 may be configured to perform one or more processes described herein, such as process 900 of FIG. 9, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive configuration information indicating a plurality of DRX configurations. The reception component 1102 and/or the transmission component 1104 may communicate in accordance with a selected DRX configuration of the plurality of DRX configurations, wherein the selected DRX configuration is associated with one or more criteria comprising at least one of a buffer status threshold, a delay status threshold, a power consumption threshold, or an active bandwidth part condition of the UE.

The communication manager 1106 may communicate in accordance with the selected DRX configuration based on comparing the buffer status threshold and a buffer status indicated by the buffer status report.

The communication manager 1106 may communicate in accordance with the selected DRX configuration based on comparing the delay status threshold and a delay status indicated by the delay status report.

The transmission component 1104 may transmit an indication of the selected DRX configuration.

The reception component 1102 may receive signaling that indicates the active bandwidth part.

The reception component 1102 may receive a configuration of the one or more criteria.

The communication manager 1106 may select the selected DRX configuration in accordance with the one or more criteria.

The reception component 1102 may receive configuration information indicating a plurality of SSS or SSSG configurations. The reception component 1102 and/or the transmission component 1104 may communicate in accordance with a selected SSS or SSSG configuration of the plurality of SSS or SSSG configurations, wherein the selected SSS or SSSG configuration is associated with one or more criteria comprising at least one of a buffer status threshold, a delay status threshold, a power consumption threshold, a DRX configuration condition, or an active bandwidth part condition of the UE.

The communication manager 1106 may communicate in accordance with the selected SSS or SSSG configuration based on comparing the buffer status threshold and a buffer status indicated by the buffer status report.

The communication manager 1106 may communicate in accordance with the selected SSS or SSSG configuration based on comparing the delay status threshold and a delay status indicated by the delay status report.

The transmission component 1104 may transmit an indication of the selected SSS or SSSG configuration.

The reception component 1102 may receive signaling that indicates the active bandwidth part.

The reception component 1102 may receive a configuration of the one or more criteria.

The communication manager 1106 may select the selected SSS or SSSG configuration in accordance with the one or more criteria.

The number and arrangement of components shown in FIG. 11 are provided as an example. In practice, there may be additional components, fewer components, different components, or differently arranged components than those shown in FIG. 11.

Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving configuration information indicating a plurality of discontinuous reception (DRX) configurations; and communicating in accordance with a selected DRX configuration of the plurality of DRX configurations, wherein the selected DRX configuration is associated with one or more criteria comprising at least one of: a buffer status threshold, a delay status threshold, a power consumption threshold, or an active bandwidth part condition of the UE.

Aspect 2: The method of Aspect 1, wherein the one or more criteria comprise the buffer status threshold.

Aspect 3: The method of Aspect 2, further comprising transmitting a buffer status report, wherein communicating in accordance with the selected DRX configuration further comprises communicating in accordance with the selected DRX configuration based on comparing the buffer status threshold and a buffer status indicated by the buffer status report.

Aspect 4: The method of any of Aspects 1-3, wherein the one or more criteria comprise the delay status threshold.

Aspect 5: The method of Aspect 4, further comprising transmitting a delay status report, wherein communicating in accordance with the selected DRX configuration further comprises communicating in accordance with the selected DRX configuration based on comparing the delay status threshold and a delay status indicated by the delay status report.

Aspect 6: The method of Aspect 4, wherein the selected DRX configuration is a deactivated DRX configuration in which a DRX cycle is deactivated in association with the delay status threshold being satisfied.

Aspect 7: The method of any of Aspects 1-6, further comprising transmitting an indication of the selected DRX configuration.

Aspect 8: The method of any of Aspects 1-7, wherein the one or more criteria comprise the power consumption threshold.

Aspect 9: The method of Aspect 8, wherein the power consumption threshold is a transmit power threshold of the UE.

Aspect 10: The method of any of Aspects 1-9, wherein the one or more criteria comprise the active bandwidth part condition, wherein the active bandwidth part condition indicates that the selected DRX configuration is associated with an active bandwidth part of the UE.

Aspect 11: The method of Aspect 10, further comprising receiving signaling that indicates the active bandwidth part.

Aspect 12: The method of any of Aspects 1-11, further comprising receiving a configuration of the one or more criteria.

Aspect 13: The method of any of Aspects 1-12, further comprising selecting the selected DRX configuration in accordance with the one or more criteria.

Aspect 14: The method of Aspect 13, wherein selecting the selected DRX configuration further comprises selecting the selected DRX configuration in accordance with the one or more criteria and at least one of a logical channel or a quality of service flow.

Aspect 15: The method of Aspect 13, wherein selecting the selected DRX configuration further comprises selecting the selected DRX configuration in accordance with two or more of the buffer status threshold, the delay status threshold, the power consumption threshold, or the active bandwidth part condition.

Aspect 16: The method of any of Aspects 1-15, wherein communicating using the selected DRX configuration comprises monitoring for a physical downlink control channel in accordance with at least one of an on duration, an inactivity timer, or a cycle length defined by the selected DRX configuration.

Aspect 17: A method of wireless communication performed by a user equipment (UE), comprising: receiving configuration information indicating a plurality of search space set (SSS) or SSS group (SSSG) configurations; and communicating in accordance with a selected SSS or SSSG configuration of the plurality of SSS or SSSG configurations, wherein the selected SSS or SSSG configuration is associated with one or more criteria comprising at least one of: a buffer status threshold, a delay status threshold, a power consumption threshold, a discontinuous reception (DRX) configuration condition, or an active bandwidth part condition of the UE.

Aspect 18: The method of Aspect 17, wherein the one or more criteria comprise the buffer status threshold.

Aspect 19: The method of Aspect 18, further comprising transmitting a buffer status report, wherein communicating in accordance with the selected SSS or SSSG configuration further comprises communicating in accordance with the selected SSS or SSSG configuration based on comparing the buffer status threshold and a buffer status indicated by the buffer status report.

Aspect 20: The method of any of Aspects 17-19, wherein the one or more criteria comprise the delay status threshold.

Aspect 21: The method of Aspect 20, further comprising transmitting a delay status report, wherein communicating in accordance with the selected SSS or SSSG configuration further comprises communicating in accordance with the selected SSS or SSSG configuration based on comparing the delay status threshold and a delay status indicated by the delay status report.

Aspect 22: The method of any of Aspects 17-21, further comprising transmitting an indication of the selected SSS or SSSG configuration.

Aspect 23: The method of any of Aspects 17-22, wherein the one or more criteria comprise the power consumption threshold.

Aspect 24: The method of Aspect 23, wherein the power consumption threshold is a transmit power threshold of the UE.

Aspect 25: The method of any of Aspects 17-24, wherein the one or more criteria comprise the active bandwidth part condition, wherein the active bandwidth part condition indicates that the selected SSS or SSSG configuration is associated with an active bandwidth part of the UE.

Aspect 26: The method of Aspect 25, further comprising receiving signaling that indicates the active bandwidth part.

Aspect 27: The method of any of Aspects 17-26, further comprising receiving a configuration of the one or more criteria.

Aspect 28: The method of any of Aspects 17-27, further comprising selecting the selected SSS or SSSG configuration in accordance with the one or more criteria.

Aspect 29: The method of Aspect 28, wherein selecting the selected SSS or SSSG configuration further comprises selecting the selected SSS or SSSG configuration in accordance with the one or more criteria and at least one of a logical channel or a quality of service flow.

Aspect 30: The method of Aspect 28, wherein selecting the selected SSS or SSSG configuration further comprises selecting the selected SSS or SSSG configuration in accordance with two or more of the buffer status threshold, the delay status threshold, the power consumption threshold, or the active bandwidth part condition.

Aspect 31: The method of any of Aspects 17-30, wherein communicating in accordance with the selected SSS or SSSG configuration comprises monitoring for a physical downlink control channel in one or more search spaces defined by the selected SSS or SSSG configuration.

Aspect 32: The method of aspect 9, further comprising transmitting a communication at a transmit power, wherein communicating in accordance with the selected DRX configuration further comprises communicating in accordance with the selected DRX configuration based on comparing the transmit power threshold and the transmit power.

Aspect 33: The method of aspect 24, further comprising transmitting a communication at a transmit power, wherein communicating in accordance with the selected SSS or SSSG configuration further comprises communicating in accordance with the selected SSS or SSSG configuration based on comparing the transmit power threshold and the transmit power

Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-33.

Aspect 35: An apparatus for wireless communication at a device, the apparatus comprising one or more memories and one or more processors coupled to the one or more memories, the one or more processors configured to cause the device to perform the method of one or more of Aspects 1-33.

Aspect 36: An apparatus for wireless communication, the apparatus comprising at least one means for performing the method of one or more of Aspects 1-33.

Aspect 37: A non-transitory computer-readable medium storing code for wireless communication, the code comprising instructions executable by one or more processors to perform the method of one or more of Aspects 1-33.

Aspect 38: A non-transitory computer-readable medium storing a set of instructions for wireless communication, the set of instructions comprising one or more instructions that, when executed by one or more processors of a device, cause the device to perform the method of one or more of Aspects 1-33.

Aspect 39: A device for wireless communication, the device comprising a processing system that includes one or more processors and one or more memories coupled with the one or more processors, the processing system configured to cause the device to perform the method of one or more of Aspects 1-33.

Aspect 40: An apparatus for wireless communication at a device, the apparatus comprising one or more memories and one or more processors coupled to the one or more memories, the one or more processors individually or collectively configured to cause the device to perform the method of one or more of Aspects 1-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a user equipment (UE), comprising:
one or more memories; and
one or more processors, coupled to the one or more memories, configured to cause the UE to:
receive configuration information indicating a plurality of discontinuous reception (DRX) configurations; and
communicate in accordance with a selected DRX configuration of the plurality of DRX configurations, wherein the selected DRX configuration is associated with one or more criteria comprising at least one of:
a buffer status threshold,
a delay status threshold,
a power consumption threshold, or
an active bandwidth part condition of the UE.

2. The apparatus of claim 1, wherein the one or more criteria comprise the buffer status threshold.

3. The apparatus of claim 2, wherein the one or more processors are further configured to cause the UE to transmit a buffer status report, wherein, to cause the UE to communicate in accordance with the selected DRX configuration, the one or more processors are further configured to cause the UE to communicate in accordance with the selected DRX configuration based on comparing the buffer status threshold and a buffer status indicated by the buffer status report.

4. The apparatus of claim 1, wherein the one or more criteria comprise the delay status threshold.

5. The apparatus of claim 4, wherein the one or more processors are further configured to cause the UE to transmit a delay status report, wherein, to cause the UE to communicate in accordance with the selected DRX configuration, the one or more processors are further configured to cause the UE to communicate in accordance with the selected DRX configuration based on comparing the delay status threshold and a delay status indicated by the delay status report.

6. The apparatus of claim 4, wherein the selected DRX configuration is a deactivated DRX configuration in which a DRX cycle is deactivated in association with the delay status threshold being satisfied.

7. The apparatus of claim 1, wherein the one or more processors are further configured to cause the UE to transmit an indication of the selected DRX configuration.

8. The apparatus of claim 1, wherein the one or more criteria comprise the power consumption threshold.

9. The apparatus of claim 8, wherein the power consumption threshold is a transmit power threshold of the UE.

10. The apparatus of claim 9, wherein the one or more processors are further configured to cause the UE to transmit a communication at a transmit power, wherein, to cause the UE to communicate in accordance with the selected DRX configuration, the one or more processors are further configured to cause the UE to communicate in accordance with the selected DRX configuration based on comparing the transmit power threshold and the transmit power.

11. The apparatus of claim 1, wherein the one or more criteria comprise the active bandwidth part condition, wherein the active bandwidth part condition indicates that the selected DRX configuration is associated with an active bandwidth part of the UE.

12. The apparatus of claim 11, wherein the one or more processors are further configured to cause the UE to receive signaling that indicates the active bandwidth part.

13. The apparatus of claim 1, wherein the one or more processors are further configured to cause the UE to receive a configuration of the one or more criteria.

14. The apparatus of claim 1, wherein the one or more processors are further configured to cause the UE to select the selected DRX configuration in accordance with the one or more criteria.

15. The apparatus of claim 14, wherein the one or more processors, to cause the UE to select the selected DRX configuration, are configured to cause the UE to select the selected DRX configuration in accordance with the one or more criteria and at least one of a logical channel or a quality of service flow.

16. The apparatus of claim 14, wherein the one or more processors, to cause the UE to select the selected DRX configuration, are configured to cause the UE to select the selected DRX configuration in accordance with two or more of the buffer status threshold, the delay status threshold, the power consumption threshold, or the active bandwidth part condition.

17. The apparatus of claim 1, wherein the one or more processors, to cause the UE to communicate using the selected DRX configuration, are configured to cause the UE to monitor for a physical downlink control channel in accordance with at least one of an on duration, an inactivity timer, or a cycle length defined by the selected DRX configuration.

18. An apparatus for wireless communication at an UE, comprising:
one or more memories; and
one or more processors, coupled to the one or more memories, configured to cause the UE to:
receive configuration information indicating a plurality of search space set (SSS) or SSS group (SSSG) configurations; and
communicate in accordance with a selected SSS or SSSG configuration of the plurality of SSS or SSSG configurations, wherein the selected SSS or SSSG configuration is associated with one or more criteria comprising at least one of:
a buffer status threshold,
a delay status threshold,
a power consumption threshold,
a discontinuous reception (DRX) configuration condition, or
an active bandwidth part condition of the UE.

19. The apparatus of claim 18, wherein the one or more processors, to cause the UE to communicate in accordance with the selected SSS or SSSG configuration, are configured to cause the UE to monitor for a physical downlink control channel in one or more search spaces defined by the selected SSS or SSSG configuration.

20. A method of wireless communication performed by a user equipment (UE), comprising:
receiving configuration information indicating a plurality of discontinuous reception (DRX) configurations; and
communicating in accordance with a selected DRX configuration of the plurality of DRX configurations, wherein the selected DRX configuration is associated with one or more criteria comprising at least one of:
a buffer status threshold,
a delay status threshold,
a power consumption threshold, or
an active bandwidth part condition of the UE.
